(19) United States
(12) Patent Application Publication
(10) Pub. No.: US 2011/0306025 A1
(43) Pub. Date: Dec. 15, 2011

(54) Ultrasound Training and Testing System with Multi-Modality Transducer Tracking

(75) Inventors: Florence Sheehan, Mercer Island, WA (US); Catherine M. Otto, Seattle, WA (US); Edward L. Bolson, Redmond, WA (US); Mark D. Anderson, Stanwood, WA (US)

(73) Assignees: higher education, Seattle, WA (US); The University of Washington through its Center for Commercialization, a public institution of

(21) Appl. No.: 13/107,632

(22) Filed: May 13, 2011

Related U.S. Application Data
(60) Provisional application No. 61/334,451, filed on May 13, 2010.

(51) Int. Cl. G09B 23/28

(52) U.S. Cl. 434/267

(57) ABSTRACT

An apparatus and a method reproduce a diagnostic or interventional procedure that is performed by medical personnel using ultrasound imaging. A simulator of ultrasound imaging is used for purposes such as training medical professionals, evaluating their competence in performing ultrasound-related procedures, and maintaining, refreshing, or updating those skills over time.

### CROSS-REFERENCE TO RELATED APPLICATIONS

This application claims priority to U.S. Provisional Patent Application Serial No. 61/334,451 filed on May 13, 2010, which is hereby incorporated by reference in its entirety.

### STATEMENT OF U.S. GOVERNMENT INTEREST

This invention was made with U.S. government support under grant number NAG9: 1258 awarded by the National Aeronautics and Space Administration, and grant number EB003849 awarded by the National Institutes of Health. The government has certain rights in the invention.

### BACKGROUND

Ultrasonography is used for imaging patients for diagnosis or for guiding interventions. During a typical ultrasound procedure, an ultrasound transducer is manipulated over or within the body of the patient to acquire images of the patient's tissues. Performing ultrasonography requires technical skill in positioning and orienting the transducer so that a two-dimensional tomographic view in the desired anatomic location is obtained, as well as cognitive skill or knowledge to interpret the images and make the correct diagnosis.

To acquire these skills, trainees typically practice on live patients at a medical institution. However, this approach has a number of drawbacks. First, recent cut-backs in physician working hours render it difficult for residents to receive the required training Second, the shortening of hospital stays further reduces opportunities for training physicians as the patients in the hospital are more ill and require more care, leaving faculty with less time available for teaching. Third, not all trainees learn at the same rate. Greater teaching efficiency may be achieved by a proficiency-based approach; this, however, would require a method for measuring competence.

The current medical educational system for competency testing in ultrasound trains and certifies physicians based on the duration of patient exposure and the number of procedures performed, but does not measure competence in procedural performance for certification or re-certification. Skill competency has always been difficult to assess in a manner that is objective and reproducible between instructors. Unlike knowledge, judgment, and process thinking, which are assessed by written and oral examinations, there is no standardized assessment method for technical skills such as competency with ultrasounds. Some studies report success using the Objective Structured Assessment of Technical Skills which uses direct instructor observation accompanied by a checklist detailing the component skills; however its reliance on instructor observation renders this approach subjective.

Without competency testing, agencies are continuing their tradition of certifying ultrasound practitioners based on experience using guidelines developed by consensus. Trainees are not tested to determine whether they are performing the procedure correctly. This contrasts with the benefits of simulator-based systems for performance-based training, objective testing, and continuing practice to maintain skills.

The problem is not limited to the training period. Assurance of competence is equally important for practicing physicians seeking to refresh skills following deployment to the battlefield or other absences such as family leave, and for those wishing to continue their education. A review of malpractice claims due to medical error found that the most complications were caused by experienced physicians, underlining the need for both continuing education and better assessment techniques.

The use of ultrasound in clinical medicine now is widespread and likely to grow as systems become smaller and less expensive, and as the range of clinical situations and locations where this approach is useful grows. Physicians in fields other than radiology and cardiology, and who are therefore not certified in ultrasound are performing diagnostic and interventional ultrasound procedures following short training courses. Examples of the diagnostic use of ultrasound include evaluation of acute chest or abdominal pain by emergency room physicians, preoperative risk assessment by anesthesiologists, evaluation of cardiac function in hypotensive patients by intensivists, and evaluation of a murmur by internists. Examples of the interventional use of ultrasound include guidance of central line catheterization, fluid drainage from the chest or abdominal cavity, and suprapubic bladder catheter placement. There is controversy but no consensus concerning the amount of training that should be required before non-certified physicians perform ultrasound in applications such as these. The lack of competency testing in ultrasound also complicates the study of skills retention following a short course, and the benefit of continuing medical education on mitigating skills erosion. In the meantime, while academics ponder the training requirements, sales in hand-carried ultrasound units are growing rapidly. Thus there is an increasing need for methods to provide efficient training and for competency testing.

Ultrasound simulators have been developed to address the training need. An ultrasound simulator typically comprises a mannequin, a simulated transducer, and a computer. The trainee manipulates a simulated transducer on a mannequin as if imaging a live patient, and the computer displays previously acquired images in a view corresponding to the position and orientation of the simulated transducer on the mannequin. The advantages of training on a simulator include compensation for the lack of patient availability, possibility of skills practice at any time, reduction in exposure and embarrassment for the live patient, clinical cost savings from allocation of patient exam rooms and facilities to teaching, and standardization of training programs across the country. Organizations involved in the certification of training programs for medical professionals are moving toward recommendation and even requirement of ultrasound simulation in some fields.

However, the ultrasound simulators currently in the marketplace have several limitations that reduce their effectiveness. The first major limitation of currently marketed ultrasound simulators is the lack of a method for competency testing. Specifically there is a lack objective and quantitative metrics for assessing physician competence in the acquisition and interpretation of ultrasound images. Simulation is particularly effective for this task. The development of competency test metrics on an ultrasound simulator would have many benefits. For example it would a) enable standardization of certification testing across the country to remove variability in test difficulty; b) remove dependency of testing and training on availability of live patients; c) enable measurement of ultrasound skill retention over time following training; d) enable assessment of the benefit of interventions such as continuing medical education to prevent or mitigate skill erosion; e) save health care costs by deferring training and testing on live patients until the trainee has mastered basic skills so that use of valuable clinic resources is minimized; and f) improve training efficiency by focusing remedial training on the areas of inadequacy while allowing faster learners to advance.

Another major limitation of currently marketed ultrasound simulators is the paucity of tools for training The fundamental reason why ultrasonography is difficult to learn is because the only clue to the location and orientation of the image plane relative to anatomy is the appearance of the target organ on the image. That is, trainees have difficulty learning to interpret three-dimensional anatomy from two-dimensional images that slice through the target organ in random planes. The training is further confounded by the necessity of practicing on live patients who have abnormal anatomic findings, whose hearts are all beating at different heart rates, and whose images vary widely in quality. Current simulators have addressed some of these by providing excellent quality images, and three-dimensional reconstructions of the anatomy showing the location of the image plane corresponding to the position of the simulated transducer on the mannequin. However to learn how to diagnose pathology requires the trainee to first acquire an image in the same anatomic view as illustrated in a textbook example of that pathology. The trainee must also consider multiple possible diagnoses by comparing the image that she obtained with views in textbooks; however the comparison studies may be illustrated in different anatomic views; in this case the trainee must acquire images in the views that match those in the textbook in order to perform the comparison. Thus the necessity of obtaining images in the same anatomic view plane makes the process of learning slow and tedious. The trainee must also consider multiple severities of each diagnosis, which also presents different appearances in the images. The learning process could be facilitated by having the simulator present the comparison studies in the same anatomic view as the image that the trainee has acquired on the simulator. Another way to facilitate learning is to present the comparison study with the heart beat synchronized to the study being imaged on the mannequin. Yet another method is to enable the trainee to scroll through multiple comparison studies to visually match the appearance of the current study with that of the comparison studies. Similarly, it would be helpful if the trainee could visually match the current study with comparison studies with the same diagnosis but different severities of that medical condition. It would also be helpful if the trainee could visually compare the current study with other studies having diagnoses that may appear similar but are incorrect, to learn how to avoid diagnostic errors.

Yet another major limitation of currently marketed ultrasound simulators is that they are expensive. The cost of a simulator places a burden on medical training programs, which have traditionally provided training in return for reduced remuneration for patient care service, and which therefore lack any budget for educational expenses. A large part of the cost of the simulator is the system employed to track the position and orientation of the simulated transducer. There are several modalities for tracking an object in three-dimensional space: magnetic, optical, acoustic, and inertial. When utilized alone, magnetic, optical, and acoustic tracking systems each can provide highly accurate six degree-of-freedom tracking, called such because three coordinates of position (x, y, and z) and three angles of orientation (azimuth, elevation, roll) are tracked. All of these modalities of tracking are expensive. Inertial systems sense motion using accelerometers and rotation using gyroscopes. Inertial systems are not accurate at measuring position because they suffer from drift when the tracked object ceases to move. However inertial systems are so inexpensive that remote control devices for computer games combine an inertial device to track orientation together with either a) a magnetometer to sense position by referencing the direction of the earth's magnetic field, or b) an infrared sensor to sense position by referencing infrared signals from emitters placed around the television screen. These game remote control devices lack the tracking accuracy required for an ultrasound simulator.

There is a need for a method for a six degree-of-freedom tracking device that meets the accuracy requirements of an ultrasound simulator and is inexpensive.

### SUMMARY

In accordance with the present invention, an apparatus and a method are defined for simulating a diagnostic or interventional ultrasound procedure. In one embodiment, the method may comprise receiving a position of a simulated ultrasound transducer relative to a part of a simulated body, generating an image data set from image data stored in data storage to the received position, selecting and displaying the generated image on a display, and displaying at least one of: a three-dimensional reconstruction of anatomy shown in the selected image data set, a three-dimensional reconstruction of a plane of the correlated image, a three-dimensional reconstruction of an anatomically defined image plane for a specified view of the body part displayed in the image, and an image of a variation of the anatomy shown in the selected image data set.

In another embodiment, a physical computer-readable storage medium having stored thereon instructions executable by a device to cause the device to perform functions is provided. The instructions comprise receiving a position of a simulated ultrasound transducer relative to a part of a simulated body, generating an image data set from image data stored in data storage to the received position, selecting and displaying the generated image on a display, and displaying a three-dimensional reconstruction of anatomy shown in the selected image data set, a three-dimensional reconstruction of a plane of the generated image, and a three-dimensional reconstruction of an anatomically defined image plane for a specified view of the body part displayed in the image.

In yet another embodiment, a device is provided. The device comprises a first interface configured to couple to a simulated ultrasound transducer, a processor, data storage, and program instructions stored in data storage and executable by the processor to cause the computing device to receive a position of a simulated ultrasound transducer relative to a part of a simulated body, generate an image data set from image data stored in data storage to the received position, select and display the generated image on a display, and display at least one of: a three-dimensional reconstruction of anatomy shown in the selected image data set, a three-dimensional reconstruction of a plane of the generated image, a three-dimensional reconstruction of an anatomically defined image plane for a specified view of the body part displayed in the image, and an image of a variation of the anatomy shown for the selected image data set.

The apparatus and method provide real-time reproduction of a diagnostic or interventional ultrasound procedure. The apparatus simulates the hardware of an ultrasound machine, with a transducer, a display unit, and requisite controls. The technical and the cognitive stages of an actual diagnostic ultrasound procedure are reproduced, including image acquisition by scanning (manipulating the transducer over the simulated body or body part), viewing the reproduced images on the display unit, utilizing information from the images to optimize the transducer position and orientation for image acquisition, and diagnosis. The technical and cognitive stages of utilizing ultrasound are also reproduced to guide an actual interventional procedure including image acquisition, viewing the reproduced images on the display unit, utilizing information from the images to optimize the transducer position, and orientation for visualizing the anatomy of the targeted body part, the interventional device, and performing the intervention. This allows the operator to practice the procedure as if performing on a live patient, as well as to practice the hand-eye coordination required of the procedure, and to recognize key anatomic landmarks on the images when viewed in various perspectives.

The stored image data may comprise ultrasound images previously acquired by scanning live patients. The stored image data may also comprise synthetic ultrasound images.

Real-time reproduction of ultrasound imaging may be provided. As the operator manipulates the simulated transducer over the simulated body or body part, the processor displays two-dimensional images prepared from stored image data. The two-dimensional images are prepared such that the images provide a view that is anatomically appropriate to the position and orientation of the transducer on the simulated body or body part.

A second window of the display unit for display of the three-dimensional anatomy of the body part being scanned with the simulated transducer may be provided. The location and orientation of the image plane being acquired relative to the anatomy can be presented. The location and orientation of the anatomically defined image plane for specified views can also be presented relative to the anatomy.

Alternatively, the second window of the display may contain images of variations on the anatomy shown in the selected image data set. A plurality of variations can be presented that are all in the same anatomical view. If the anatomy includes an organ that exhibits motion, the variations can be presented with motion at the same velocity and direction or orientation.

In one embodiment, the invention enables competency testing that is quantitative and objective, and that may encompass skill as well as knowledge. For each type of ultrasound procedure, a set of learning objectives defined by experts in ultrasound and in medical education is employed to define the test metrics. Testing of competency is performed according to achievement of learning objectives specific for each ultrasound application and for the level of the operator. For example, learning objectives for a medical student are less rigorous than those for a fellow in cardiology. The types of test metrics for competency testing may include but are not restricted to: error in the position and orientation of an image plane acquired from the simulator calculated relative to the anatomically defined image plane, error in measurements made by the operator from one or more acquired images calculated relative to measurements made from the stored image data, and error in diagnosis. Preferably the curriculum directs operators to advance to more difficult objectives as testing documents the mastery of primary skills.

The tracking device may perform six degree-of-freedom tracking of the position and orientation of an object using one or more tracking modalities. One embodiment may include employing an infrared sensor to enable accurate position and orientation tracking of the simulated transducer.

These as well as other aspects and advantages will become apparent to those of ordinary skill in the art by reading the following detailed description, with reference where appropriate to the accompanying drawings.

### BRIEF DESCRIPTION OF THE FIGURES

FIG. 1 depicts an exemplary ultrasound simulator system, in accordance with at least one embodiment;

FIG. 2a depicts an exemplary simulated transducer and simulated body part for the example ultrasound simulator system, in accordance with at least one embodiment;

FIG. 2b depicts the exemplary simulated transducer and simulated body part of FIG. 2a in operation;

FIG. 2c depicts a top view of a plurality of emitter clusters that may reside within the exemplary simulated body part of FIG. 2a;

FIG. 3a depicts a visualization of an exemplary organ from a single pyramidal volume of image data using a three-dimensional ultrasound machine;

FIG. 3b depicts a visualization of an exemplary organ from a plurality of images from an image storage using a three-dimensional ultrasound machine;

FIG. 4 depicts the exemplary ultrasound simulator system of FIG. 1, in accordance with at least one embodiment;

FIG. 5 depicts a simplified flow diagram of an example method that may be carried out by the example ultrasound simulator system, in accordance with at least one embodiment; and

FIG. 6 depicts a simplified flow diagram of an example method that may be carried out by the example ultrasound simulator system, in accordance with at least one embodiment.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

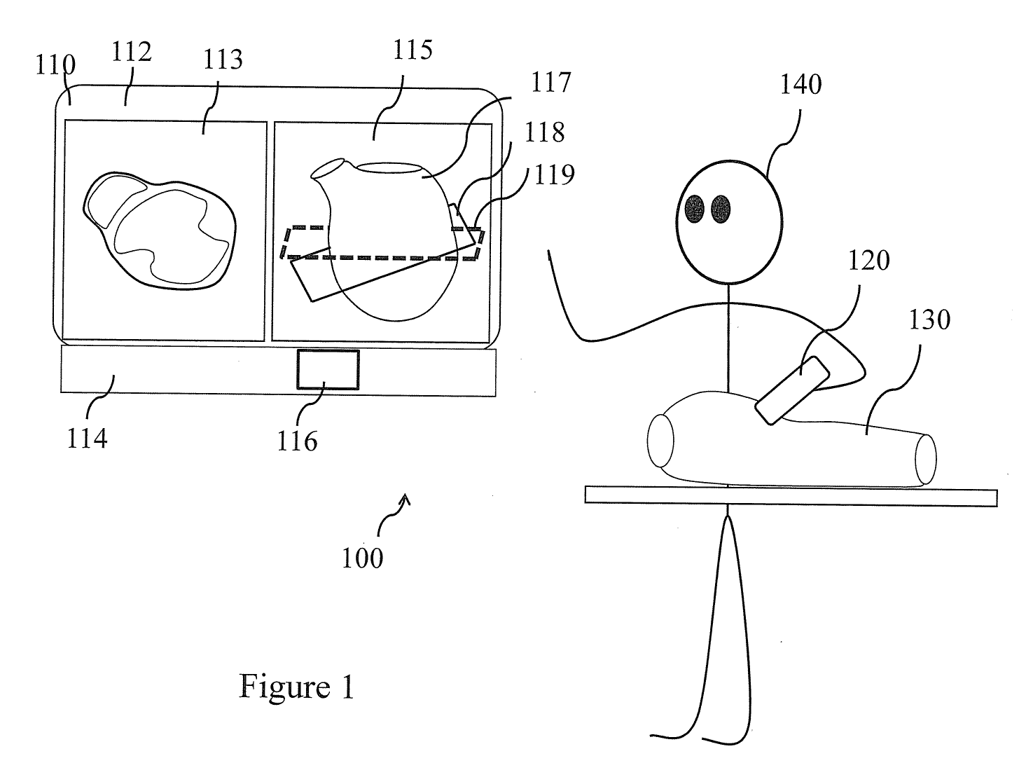

FIG. 1 depicts an exemplary ultrasound simulator system in accordance with at least one embodiment of the present application. In one system 100, a device with a user interface 110 may contain hardware to enable a wired or wireless communication link. The device with user interface 110 is coupled to a simulated ultrasound transducer 120 with a communication link, and may be coupled to communicate with other devices as well. The communication link may also be used to transfer image or textual data to the user interface 110 from other sources, or may be used to transfer unprocessed data, for example.

The communication link connecting the device with user interface 110 with the simulated ultrasound transducer 120 may be one of many communication technologies. For example, the communication link may be a wired link via a serial bus such as USB, or a parallel bus. A wired connection may be a proprietary connection as well. The communication link may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities.

The device with user interface 110 comprises a display 112. The device with user interface 110 may also comprise a processor 114, and data storage storing image data and logic 116. These elements may be coupled by a system bus or other mechanism. The processor 114 may be or may include one or more general-purpose processors and/or dedicated processors, and may be configured to compute displayed images based on received data. The processor 114 may be configured to perform an analysis on the orientation, position, or movement determined by the simulated ultrasound transducer 120 so as to produce an output. An output interface may be configured to transmit the output to the display 112. The device with user interface 110 may include elements instead of and/or in addition to those described.

The system 100 also comprises a simulated body part 130, and an operator 140. In the present embodiment, the operator 140 may manipulate the simulated ultrasound transducer 120 and view the display 112.

Display 112 comprises a first window 113 and a second window 115. In the first window 113, a two-dimensional image is displayed. In the second window 115, a three-dimensional reconstruction of the anatomy 117 shown in the first window 113 is displayed, including a reconstruction of an anatomically defined image plane 118 and a reconstruction of a plane of the image generated by the operator 119.

The anatomically defined image plane may be an anatomically correct image plane. The anatomically defined image plane is identified analytically from the three-dimensional reconstruction. For example, the four-chamber view of the heart is the two-dimensional image obtained in a plane defined by the centroids of the mitral and tricuspid valve annuli and the apex of the heart. The coordinates of analytically defined image planes are in the same space as the acquired image. A graphic of such a plane may be displayed with the three-dimensional reconstruction for comparison with the acquired image plane.

For some organs, the anatomically defined image plane may be the plane that visualizes the organ in its maximum dimension such as length or cross sectional area. For other organs, such as the heart, the anatomically defined image plane may be the plane that visualizes specific anatomic landmarks. For example, the apical four chamber view of the heart may be defined as taught by King D L, et al., Ultrasound Beam Orientation During Standard Two-Dimensional Imaging: Assessment by Three-Dimensional Echocardiography, 5 J. Am. Soc. of Echocardiography 569-576 (1992) incorporated herein by reference, as a plane passing through the center of the left ventricle of the heart and parallel to the left ventricular central long axis, and further refined by C. M. Otto, Textbook of Clinical Echocardiography, 4th ed. (2009), incorporated herein by reference, as also passing through the mitral valve at its largest diameter. It will be noted that the definition of the anatomically defined plane for a specified view may vary between experts. For example, M. N. Allen, Echocardiography, 2d ed. (1999), incorporated herein by reference, teaches that the apex of the left ventricle should appear at the center of the sector where the septum and lateral wall meet and should almost come to a point, the mitral and tricuspid valves should swing open widely in the absence of pathology, the walls of the left and right atria should be clearly seen, pulmonary veins should be seen entering the left atrium, and the right ventricle should appear as a triangular shape in the absence of pathology. However this definition should not be taken as a disagreement with the definition of the references King D L et al. and Otto because the Allen reference describes the desired result rather than prescribing the view.

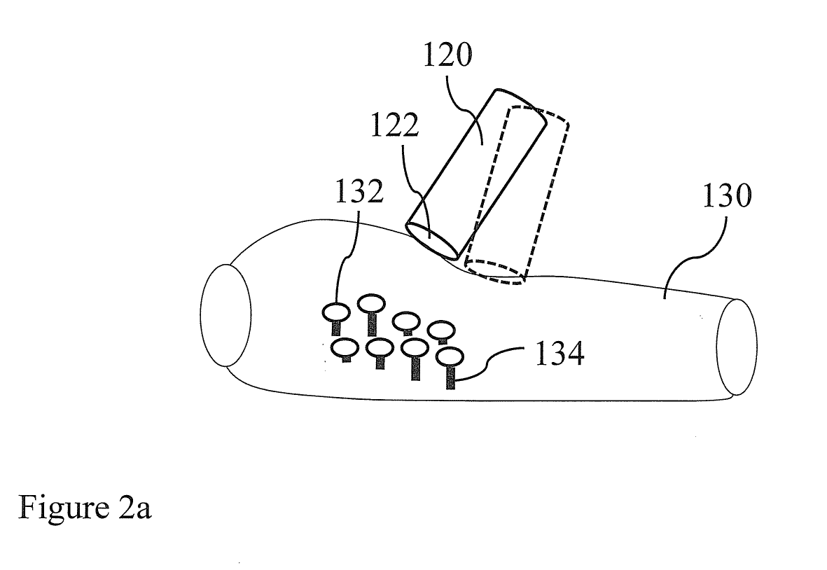

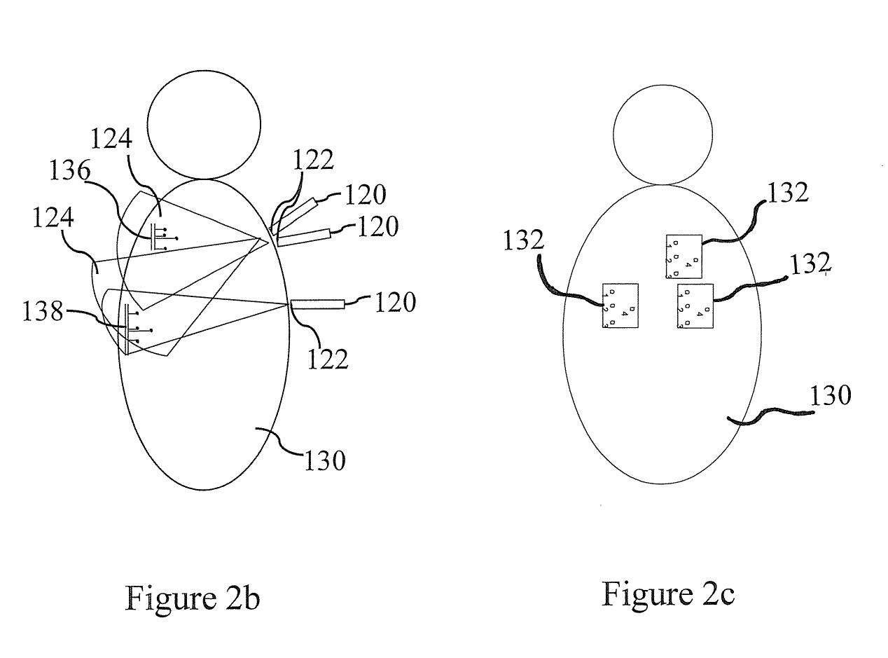

FIG. 2a depicts an exemplary simulated ultrasound transducer and simulated body part for an example ultrasound simulator system such as the example system 100, in accordance with at least one embodiment. The simulated ultrasound transducer 120 comprises an infrared sensor 122 at one end. The simulated body part 130 comprises a plurality of infrared emitters 132.

The plurality of infrared emitters 132 may be a cluster of emitters. FIG. 2a depicts one such cluster of four infrared emitters 132. Each infrared emitter comprises a pedestal 134, and may be any standard infrared emitter known in the art. In the present example, each of the plurality of infrared emitters 132 is the same emitter with the exception of the height of their respective pedestals 134. The varying heights of the pedestals (resulting in a varying height of the emitters on top of the pedestals) may comprise a distinct spatial pattern that is detectable by the simulated ultrasound transducer 120.

The infrared emitters 132 are configured in such spatial patterns that permit recognition of each cluster's identity, to enable calculation of the infrared sensor's position in three-dimensional space. The spatial pattern may be nonplanar (tetrahedral) to provide orientation angle discrimination; specifically, an inverse viewing transformation is performed on data from the infrared sensor 122 and the infrared emitter 132 geometry to determine the viewing angle of the simulated transducer relative to the known three-dimensional target geometry. An iterative algorithm for determining best fit of the transformed data, thereby yielding accurate relative angle and distance is commonly known in the art as the POSIT (Pose from Orthographic and Scaling with Iterations) Algorithm.

The infrared emitters 132 may also fluctuate in intensity over time at frequencies that aid in identifying specific emitter groups, as needed to enable accurate calculation of the infrared sensor's spatial position. The infrared sensing of spatial position is combined with the simulated ultrasound tracking device's measurement of orientation to provide six degree-of-freedom tracking of the simulated ultrasound transducer 120.

In operation, the end of the simulated ultrasound transducer 120 with the infrared sensor 122 is positioned on the simulated body part 130. As an operator moves the simulated ultrasound transducer 120 to a different position and/or orientation (as illustrated by the dashed lines), the coordinates of the new position and orientation are computed, at least in part, from the pattern detected from the presence of the plurality of infrared emitters 132.

The coordinates of position and orientation may be measured using a six degree-of-freedom tracking device. One application of the six degree-of-freedom tracking device is to register the image data sets in the memory unit to the position and orientation of the simulated body or body part at the beginning of each use.

Another application of the six degree-of-freedom tracking device is to measure the position and orientation of the simulated ultrasound transducer 120 in real time as the operator 130 is manipulating the transducer 120 over the simulated body part 130. The tracking data are used to compute the location of the two-dimensional ultrasound image plane that corresponds spatially to the location of the simulated ultrasound transducer 120 on the simulated body or body part 130.

In an alternative embodiment, inertial guidance may be utilized in combination with infrared sensing to improve accuracy and precision of tracking The tracking data from such other modalities will be fused with infrared sensor data using methods such as Kalman filtering.

FIG. 2b depicts the exemplary simulated ultrasound transducer 120 and simulated body part 130 of FIG. 2a in operation. In FIG. 2b, a first cluster of infrared emitters 136 and a second cluster of infrared emitters 138 are shown. As the simulated ultrasound transducer 120 is changed in position and/or angulation by the operator over the simulated body part 130, the infrared sensor 122 may detect one of or both the first cluster of infrared emitters 136 and the second cluster of infrared emitters 138. A detection field 124 for each of the plurality of positions and/or orientations of the simulated ultrasound transducer 120 is shown.

FIG. 2c depicts a top view of a plurality of emitter clusters, such as the emitter cluster 132, which may reside within the exemplary simulated body part 130 of FIG. 2a. Each of the plurality of emitter clusters 132 may be disposed within the simulated body part 130 in positions corresponding to the expected location of certain organs within a human body. Alternatively or in combination, the emitter clusters 132 may be disposed within the simulated body part 130 in positions that facilitate the computation of the position and orientation of the sensor.

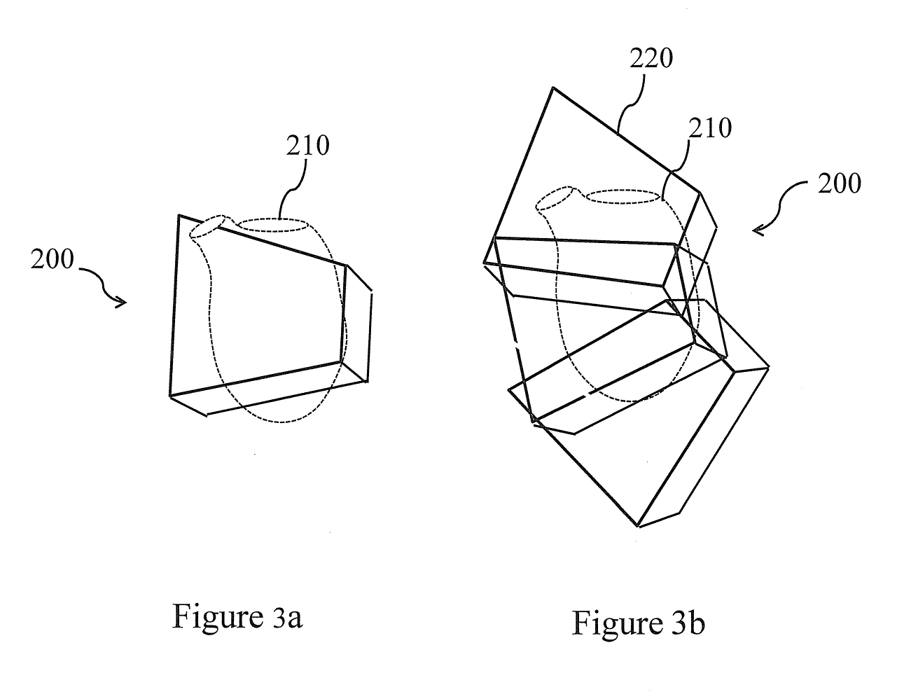

FIG. 3a depicts a visualization of a single volume of image data using a 3-dimensional ultrasound machine. In the example shown in FIG. 3a, the visualization 200 comprises a single pyramidal volume of image data comprising a portion of a heart 210. Visualization 200 illustrates the difficulty of visualizing an organ such as the heart 210 within a single pyramidal volume of image data as may be acquired using a three-dimensional ultrasound machine. The entire heart 210 is not able to be captured in the visualization 200. Although FIG. 3a depicts a human heart as the example organ, it will be understood that the organ can be any anatomic structure within a living vertebrate.

FIG. 3b depicts a visualization of the exemplary organ of FIG. 3a taken from a plurality of images from an image storage using a three-dimensional ultrasound machine. In FIG. 3b, a plurality of three-dimensional image data sets 220 from an image library are used to provide an operator with a complete visualization of the human heart 210 and any surrounding tissue.

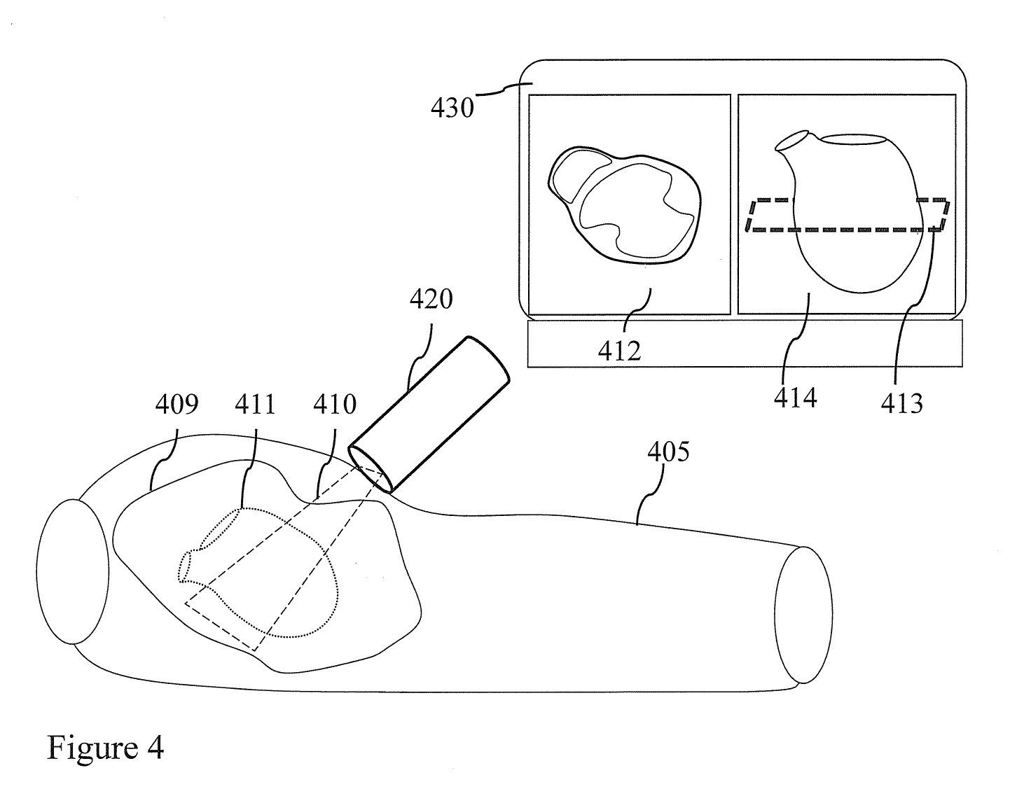

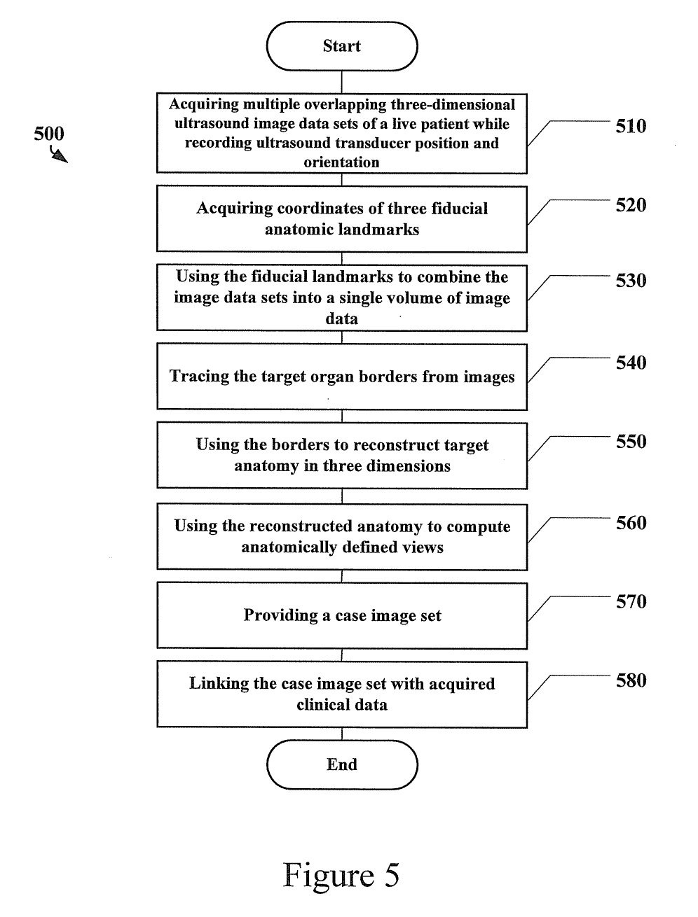

FIG. 4 depicts an exemplary ultrasound transducer system 400 in accordance with at least one embodiment. FIG. 4 shows computing an imaging plane 410 over an organ 411 and surrounding tissue 409 in a body 405 taken by an ultrasound transducer 420 using the six degree-of-freedom coordinates of the transducer 420 position and orientation. The imaging plane 410 can then be used to create a subset of a case image set, which can be presented as a two-dimensional image 412 on a display 430, such as the display 110 described with reference to FIG. 1. The case image set creation will be described in further detail with respect to FIG. 5. The image plane location 413 and a three-dimensional reconstruction of the anatomy shown in the selected image 414 may also be shown on display 430.

FIG. 5 depicts a simplified flow diagram of an example method that may be carried out to create a plurality of case image sets to install in the example ultrasound simulator system, in accordance with at least one embodiment. Method 500 shown in FIG. 5 presents an embodiment of a method that, for example, could be used with system 100.

In addition, for the method 500 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a physical and/or non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example. Alternatively, program code, instructions, and/or data structures may be transmitted via a communications network via a propagated signal on a propagation medium (e.g., electromagnetic wave(s), sound wave(s), etc.).

Initially, the method 500 includes acquiring multiple overlapping three-dimensional ultrasound image data sets of a live patient while recording ultrasound transducer position and orientation, at block 510. In the preferred embodiment, a commercial three-dimensional ultrasound machine and transducer are used in conjunction with a tracking device to record the six degree-of-freedom position and orientation of the transducer during imaging.

The image data is linked in computer files to the tracking data and is used to compute the coordinates of each voxel in three-dimensional space. The volumes of image data may be partially overlapping as needed to obtain visualization of the target organ and the tissue immediately surrounding the target organ without gaps. The volumes of image data are then assembled into a single volume of image data using a spatial compounding method that assigns a gray scale value to each voxel in the image volume after consideration of gray values in adjacent voxels.

The method 500 then includes acquiring coordinates of three fiducial anatomic landmarks, at block 520.

The method 500 includes combining the image data sets and fiducial landmarks into a single volume of image data, at block 530.

The method includes tracing the target organ borders from images, at block 540.

The method includes using the borders to reconstruct target anatomy in three dimensions, at block 550.

The method includes using the reconstructed anatomy to compute anatomically defined views, at block 560.

The method includes providing a case image set, at block 570. The case image set comprises the combined image data set, reconstructed target anatomy, and anatomically defined views.

The method includes linking the case image set with acquired clinical data, at block 580. A trainer may gather clinical data from the live patient and prepare the patient's medical history, comprising patient symptoms and other various pertinent test results, as well as records of surgery and other treatments. The trainer can prepare test questions from this clinical data, and send the data to be linked with the case image set for that particular patient. The linked clinical data with the case image set comprises a case study. Alternatively, the trainer may modify the clinical data from the live patient, for example to enhance its instructional capacity, before sending the data to be linked to the case image set.

An image library may be prepared from a plurality of such case studies, which may be representative of a field of medical practice or knowledge.

The case image sets may be positioned computationally within the simulated body or body part using a registration procedure. The registration procedure enables preparation of image data for presentation on the display that is appropriate for the position and orientation of the simulated transducer on the simulated body or body part. Specifically, as each live patient is scanned to create a case study for an image library, the coordinates of three anatomic landmarks will be measured from tracking data recorded when the ultrasound transducer is touched briefly to each landmark. At the beginning of each session on the simulator, the simulated transducer is touched to the same anatomic landmarks on the simulated body or body part to define the coordinates of these landmarks. The case image set is then registered to the simulated body or body part by translating, rotating, and scaling to match, using these landmark coordinates as fiducial markers. To save time in opening case studies, all case image sets in a library may be translated, rotated, and scaled to register them together. Each of the case image sets may be linked with its associated acquired clinical data.

The two-dimensional imaging plane of the transducer is calculated from the six degree-of-freedom coordinates of transducer position and orientation. The imaging plane is intersected with the case image set to identify a subset of image data that is presented on the display as a two-dimensional ultrasound image.

The location(s) of one or more image planes acquired from the case image set may be displayed with the three-dimensional reconstruction when the simulator is used for teaching. The three-dimensional reconstruction may be prepared by entering at least three anatomic points on the image data using an interface for image review and feature tracing. Three-dimensional reconstruction of the target organ from such sparse input data is enabled by a database that embodies knowledge of the expected shape of the target organ. For example, a piecewise smooth subdivision surface is computed as a weighted sum of surfaces in the database. The weights are determined by shape similarity to the entered points using an optimization routine that minimizes the distance from the entered points to the surface. If the target organ is a heart, the process is repeated for every time point in the cardiac cycle to enable a beating heart graphic display.

One embodiment may include a display of image data from one or more stored image data sets for visual comparison with the image data from the data currently being scanned, called image matching. Image matching is a tool for assisting the operator in learning to interpret medical ultrasound images by identifying similarities and differences between the image data set being scanned and other patients' image data sets stored in the memory unit having, for example, a similar diagnosis but different severity of disease. The comparison data set or sets may be displayed in the same anatomic view as the image data acquired on the simulated body or body part. The comparison data set or sets may be displayed with the heart beating synchronously with the image data acquired on the simulated body or body part. These options allow adjustment of the training to be easier or more difficult as needed or desire according to the ability of the operator.

Preferably, an extensive number of image data sets illustrating a wide range of pathologies and of the severities of these pathologies will be available. The image data sets may be accompanied by clinical data to enhance the realism of the training and testing. A curriculum may be established by experts in the field of ultrasound and in medical education to direct the operator of the transducer.

The image matching display may be prepared by selecting a plurality of case studies in the image library and presenting image data from them in the second window, after conversion from three-dimension to two-dimension, for side-by-side comparison with image data from the case study being scanned in the two-dimensional ultrasound window. The selected case studies are registered by three anatomic landmarks for presentation in the same anatomic view as the case study being scanned. The anatomic landmarks utilized are appropriate for the diagnosis. For example, studies illustrating coronary artery disease would be registered by the centroids of the aortic and mitral valves and the apex of the left ventricle.

The case studies in the image library may be synchronized in time by adjusting the playing time for one cardiac cycle or heart beat to equal that of the case study being scanned in the simulated body or body part. If not synchronized, then the case studies may be played at the heart rate of the live patient at the time of image acquisition.

Testing of competency in the technical skill of ultrasound acquisition measures proficiency in manipulating the transducer, identifying the anatomy of the target organ and surrounding tissues, and acquiring images in the anatomically defined image plane. In the preferred embodiment, proficiency in manipulating the transducer is assessed by measuring how well the operator maintains the target organ in the center of the image while rotating or angulating the transducer; the error is computed as the distance between the centroid of the target organ in the image plane and the centroid of the portion of the image plane that contains the image at time intervals during the test. However it will be understood that there may be other examples of proficiency testing. Error in acquiring an image in the anatomically defined image plane is computed in terms of distance and angle. The distance between the anatomically defined plane and plane acquired by the operator will be computed as the distance between a specified anatomic landmark such as the centroid of the mitral annulus in the two planes. The error in orientation will be computed as the angle between the two planes. Error in measurements of organ dimension, volume, shape, and/or function made by the operator from one or more acquired images is calculated relative to measurements made from the anatomically defined images. Error in diagnosis is assessed by comparison with the true diagnosis as defined by experts and the medical records of the patient whose image data are stored in the memory unit.

Testing of competency in ultrasound guided intervention measures proficiency in manipulating the transducer to obtain views of both the anatomical target and the needle or catheter or other device that is to be inserted into the target. For example, the Learning Objectives for ultrasound guided jugular vein catheterization (JVC) are ability to a) visualize both the jugular vein and the needle in a cross sectional view, b) position the needle over the vein using ultrasound guidance, and c) insert the needle into the vein in a safe manner. When JVC is performed safely, a) the needle does not enter the carotid artery, b) the needle stays within the jugular vein, c) the angle of needle entry is 45±10°, and d) JVC is completed in no more than 3 attempts. Error in needle position is measured directly from the tracking coordinates of the needle's tip and the coordinates of the three-dimensional reconstructions of the carotid artery and jugular vein in the case study.

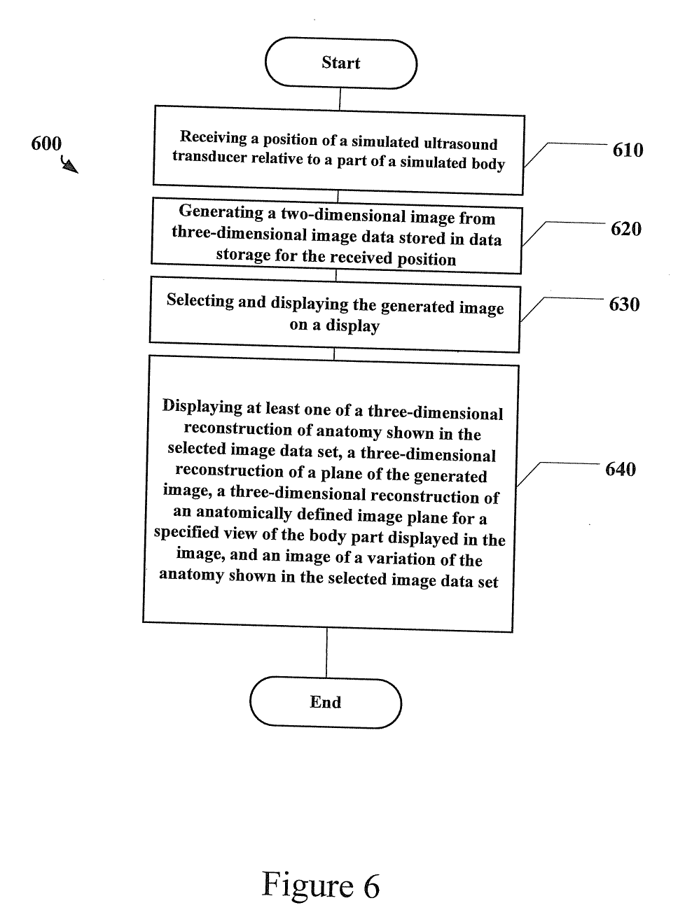

FIG. 6 depicts a simplified flow diagram of an example method that may be carried out by the example ultrasound simulator system, in accordance with at least one embodiment. Method 600 shown in FIG. 6 presents an embodiment of a method that, for example, could be used with system 100.

Initially, the method 600 includes receiving a position of a simulated ultrasound transducer relative to a part of a simulated body, at block 610.

Then, the method 600 includes generating a two-dimensional image from three-dimensional image data stored in data storage for the received position, at block 620.

The method 600 includes selecting and displaying the generated image on a display, at block 630.

The method 600 includes displaying at least one of a three-dimensional reconstruction of anatomy shown in the selected image data set, a three-dimensional reconstruction of a plane of the generated image, a three-dimensional reconstruction of an anatomically defined image plane for a specified view of the body part displayed in the image, and an image of a variation of the anatomy shown in the selected image data set, at block 640.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

What is claimed is:

1. A method comprising:
receiving a position of a simulated ultrasound transducer relative to a part of a simulated body;
generating an image data set from image data stored in data storage for the received position;
selecting and displaying the generated image data set on a display; and
displaying at least one of:
a three-dimensional reconstruction of anatomy shown in the selected image data set;
a three-dimensional reconstruction of a plane of an image from the generated image data set;
a three-dimensional reconstruction of an anatomically defined image plane for a specified view of the body part displayed in the image; and
an image of a variation of the anatomy shown in the selected image data set.

2. The method of claim 1, wherein further displaying comprises displaying all of:
the three-dimensional reconstruction of anatomy shown in the selected image data set;
the three-dimensional reconstruction of the plane of the image from the generated image data set;
the three-dimensional reconstruction of the anatomically defined image plane for the specified view of the body part displayed in the image; and
the image of the variation of the anatomy shown in the selected image data set.

3. The method of claim 1, wherein further displaying comprises at least both of:
the three-dimensional reconstruction of the plane of the image from the generated image data set; and
the three-dimensional reconstruction of the anatomically defined image plane for the specified view of the body part displayed in the image.

4. The method of claim 3, further comprising:
comparing the three-dimensional reconstruction of the plane of the generated image with the anatomically defined image plane; and
calculating the difference in at least one of orientation or position between the three-dimensional reconstruction of the plane of the generated image with the anatomically defined image plane.

5. The method of claim 1, further comprising:
calculating the difference between a measurement taken from the generated image with a measurement from an image generated from the stored image data by a different observer.

6. The method of claim 1, further comprising:
calculating a distance between a centroid of a target organ shown in the three-dimensional reconstruction of the plane and a centroid of the portion of three-dimensional reconstruction of the plane showing an image of the target organ at various time points.

7. The method of claim 1, further comprising:
in response to receiving the position of the simulated ultrasound transducer relative to the part of the simulated body, generating the image data set from the stored image data in an orientation corresponding to the received position.

8. The method of claim 1, wherein receiving the position of the simulated ultrasound transducer relative to the part of the simulated body further comprises:
receiving position and orientation information from a six degree-of-freedom tracking device on the simulated ultrasound transducer, wherein at least one infrared sensor on the tracking device communicates with at least one infrared emitter within the simulated body and uses the communication to allow for a calculation of the position and orientation of the simulated ultrasound transducer relative to the simulated body.

9. The method of claim 8, wherein the at least one infrared emitter is a cluster of emitters configured in a known spatial pattern to allow for recognition of the identity of the cluster and a calculation of the location and orientation of the simulated ultrasound transducer relative to the simulated body.

10. The method of claim 1, further comprising displaying at least one of:
instructional information; and
knowledge assessment.

11. The method of claim 10, wherein the knowledge assessment comprises assessment of a plurality of skills including at least one of:
cognitive skill; and
psychomotor skill.

12. The method of claim 11 wherein the assessment of psychomotor skill further comprises a plurality of metrics including at least one of:
calculating the difference between at least one of orientation or position between the three-dimensional reconstruction of the plane of the generated image with the anatomically defined image plane;
measuring the time to generate a two-dimensional image; and
measuring parameters of motion of the simulated ultrasound transducer in the course of generating the two-dimensional image, the parameters including rotation, angulation, and translation.

13. The method of claim 1, further comprising receiving the image data stored in the memory from at least one of:
synthetic ultrasound images; and
live patients.

14. A physical computer-readable storage medium having stored thereon instructions executable by a device to cause the device to perform functions comprising:
receiving a position of a simulated ultrasound transducer relative to a part of a simulated body;
generating an image data set from image data stored in data storage to the received position;
selecting and displaying the generated image on a display; and displaying:
a three-dimensional reconstruction of anatomy shown in the selected image data set;
a three-dimensional reconstruction of a plane of an image from the generated image data set; and
a three-dimensional reconstruction of an anatomically defined image plane for a specified view of the body part displayed in the image.

15. The physical computer readable storage medium of claim 14, wherein displaying further comprises displaying an image of a variation of the anatomy shown for the selected image data set.

16. The physical computer readable storage medium of claim 14, wherein further displaying comprises at least both of:
the three-dimensional reconstruction of the plane of an image from the generated image data set; and
the three-dimensional reconstruction of the anatomically defined image plane for the specified view of the body part displayed in the image.

17. The physical computer readable storage medium of claim 16, further comprising:
comparing the three-dimensional reconstruction of the plane of the generated image with the anatomically defined image plane; and
calculating the difference in at least one of orientation or position between the three-dimensional reconstruction of the plane of the generated image with the anatomically defined image plane.

18. The physical computer readable storage medium of claim 14, further comprising:
calculating the difference between a measurement taken from the generated image with a measurement from a selected image from the stored image data.

19. The physical computer readable storage medium of claim 14, wherein the three-dimensional reconstruction of the anatomically defined image plane is constructed from the three-dimensional reconstruction of anatomy shown in the selected image.

20. A device comprising:
a first interface configured to couple to a simulated ultrasound transducer;
a processor;
data storage; and
program instructions stored in data storage and executable by the processor to cause the computing device to:
receive a position of a simulated ultrasound transducer relative to a part of a simulated body;
generate an image data set from image data stored in data storage to the received position;
select and display the generated image on a display; and
display at least one of:
a three-dimensional reconstruction of anatomy shown in the selected image data set;
a three-dimensional reconstruction of a plane of an image from the generated image data set;
a three-dimensional reconstruction of an anatomically defined image plane for a specified view of the body part displayed in the image; and
an image of a variation of the anatomy shown for the selected image data set.
